(19) United States
(12) Patent Application Publication
(10) Pub. No.: US 2009/0223341 A1
(43) Pub. Date: Sep. 10, 2009

(54) Paper punch with consecutive operation links

(76) Inventor: Chien Chuan Huang, Chang Hua Hsien (TW)

Correspondence Address: BACON & THOMAS, PLLC, 625 SLATERS LANE, FOURTH FLOOR, ALEXANDRIA, VA, 22314-1176, US

(21) Appl. No.: 12/073,598

(22) Filed: Mar. 7, 2008

(51) Int. Cl. B26F 1/32; B26F 1/02; B26D 5/08

(52) U.S. Cl. 83/588

(57) ABSTRACT

A paper punch includes a base with a plurality of frames connected thereto and each frame includes a punch head biased by a spring, the top ends of the punch heads protrude from tops of the frames. A support part is fixed to the base and includes a plurality of connection plates to which an arm, a first link and a second link are respectively connected thereto. The top ends of the punch heads movably extend through the through holes in the support part. The arm includes an elongate recess and two respective rolling ends of the first and second links are movably engaged with the elongate recess. When pivoting the arm downward, the three top ends of the punch heads are respectively pushed by the arm, the first like and the second link.

### FIELD OF THE INVENTION

The present invention relates to a paper punch with consecutive links which activate punch heads to punch sheets in sequence so as to save effort.

### BACKGROUND OF THE INVENTION

A conventional paper punch 6 is shown in FIGS. 8 and 9, and generally includes a board 61 connected to a base and two support plates 62 extend from the board 61, and an arm 63 pivotably connected to the support plates 62. A plurality of punch units 64 are located between the board 61 and the arm 63, each punch unit 64 includes a punch head 66 to which a spring 65 is mounted. The top ends of the punch heads 66 are located beneath the arm 63 so that when pivoting the arm 63 downward, the punch heads 66 are pushed downward and the blade portions 68 on the lower ends of the punch heads 66 penetrate through sheets of paper in the slots 67 located at a lower end of the punch units 64. After releasing the arm 63, the springs 65 bounce the punch heads 66 upward.

However, it requires a significant force to punch a thick layer of sheets and the multiple punch heads are applied a strong reaction force from the sheets of paper, this makes the punching action to be difficult for some users.

The present invention intends to provide a paper punch which includes an arm, a first link and a second link, each of the arm, the first link and the second link activates a punch head in sequence so that the user can easily punch with less force applied to the arm.

### SUMMARY OF THE INVENTION

The present invention relates to a paper punch which comprises an arm having a pivotal end pivotably connected to one of connection plates of a support part fixed on a base. A torsion spring is received in the pivotal end of the arm and an elongate recess is defined in the arm. A first link includes a first rolling end movably engaged with the elongate recess in the arm and a first fixed end is connected to the other one of the connection plates on the support part. A second link includes a second rolling end movably engaged with the elongate recess in the arm and a second fixed end of the second link is pivotably connected to yet another connection plate. The second rolling end is located beneath the first rolling end. A plurality of punch units each have a frame, a punch head and a spring which is mounted to the punch head. The frames are connected beneath of the support part. Respective top ends of the punch heads extend through the through holes in the support part. The first link, the second link and the arm respectively contact the top ends of the punch heads. Respective lower ends of the punch head movably extend through the frames. The support part and the punch units are fixed to the base.

The primary object of the present invention is to provide a paper punch which includes an arm, a first link and a second link, each of which activates a punch head and the three punch heads are lowered to punch sheets of paper one by one when pivoting the arm of the paper punch. By this way, less force is needed to operated the paper punch.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show the paper punch of the present invention;

FIG. 2 is a perspective view to show the paper punch of the present invention;

FIG. 3 is a side view to show the paper punch of the present invention;

FIG. 4 shows that the arm is pivoted downward to pivot the first and second links;

FIG. 5 shows that the punch heads are lowered by continuously pivoting the arm;

FIG. 6 shows that the arm is pivoted to its lowest position and the punch heads punch the sheets of paper;

FIG. 7 shows the perspective view of the paper punch in the status in FIG. 6;

FIG. 8 is a cross sectional view to show a conventional paper punch, and

FIG. 9 shows the arm of the conventional paper punch is pivoted downward.

### DETAILED DESCRIPTION OF THE PREFERRED EMBODIMENT

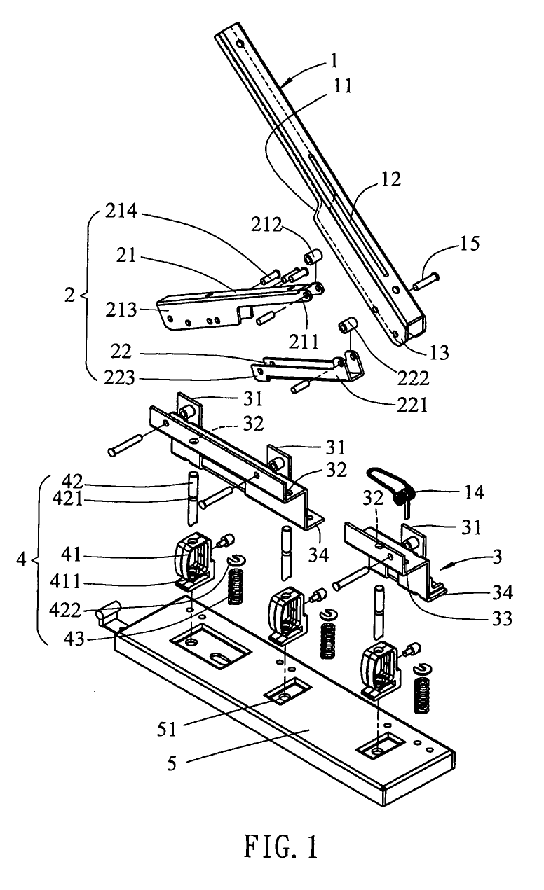

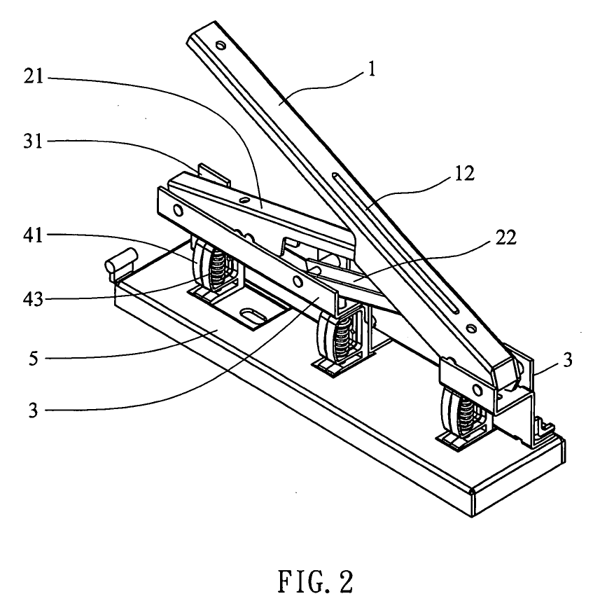

Referring to FIGS. 1 to 3, the paper punch of the present invention comprises a base 5 which has a plurality of engaging recesses 51 with which the frames 41 of the punch units 4 are engaged. A support part 3 is fixed to the base 5 by a fixing plate 34 and includes a plurality of connection plates 31 extending therefrom.

An arm 1 has a pivotal end 13 which is pivotably connected to one of the connection plates 31 and a torsion spring 14 is received in the pivotal end 13. An elongate recess 11 is defined in the arm 1 and a rail 12 extends from an inside of the elongate recess 11 of the arm 1. A first pin 15 extends through the pivotal end 13.

A link unit 2 includes a first link 21 and a second link 22, wherein the first link 21 includes a first rolling end 211 movably engaged with the rail 12 in the elongate recess 11 in the arm 1 and a first fixed end 213 which is pivotably connected to another one of the connection plates 31. The second link 22 includes a second rolling end 221 movably engaged with the rail 12 in the elongate recess 11 in the arm 1 and a second fixed end 223 which is pivotably connected to yet another connection plate 31. The first link 21 includes a first roller 212 connected to the first rolling end 211 and the second link 22 includes a second roller 222 connected to the second rolling end 221, the first and second rollers 212, 222 are movable along the rail 12 in the elongate recess 11. The second rolling end 221 is located beneath the first rolling end 211. The first link 21 includes a second pin 214 connected thereto and the second link 22 includes a flange 224 extending outward from a lower end thereof.

The support part 3 includes a plurality of through holes 32 and an aperture 33 defined through the support part 3. An end of the torsion spring 14 contacts against the first pin 15 and the other end of the torsion spring 14 is inserted into the aperture 33.

The punch units 4 each have a frame 41, a punch head 42 and a spring 43 which is mounted to the punch head 42. Each of the punch heads 42 includes a groove 421 with which a clip 422 is engaged, the springs 43 in the frames 41 contacts the clips 422 respectively. The frames 41 connected beneath of the support part 3 and respective top ends of the punch heads 42 extend through the through holes 32 in the support part 3. The second pin 214 of the first link 21, the flange 224 of the second link 22 and the first pin 15 of the arm 1 respectively contact the top ends of the punch heads 42. Respective lower ends of the punch head 42 movably extend through the frames 41 and the slots 411 located at lower ends of the frames 41. Paper sheets can be inserted into the slots 411 so as to be punched when the punch heads 42 are lowered.

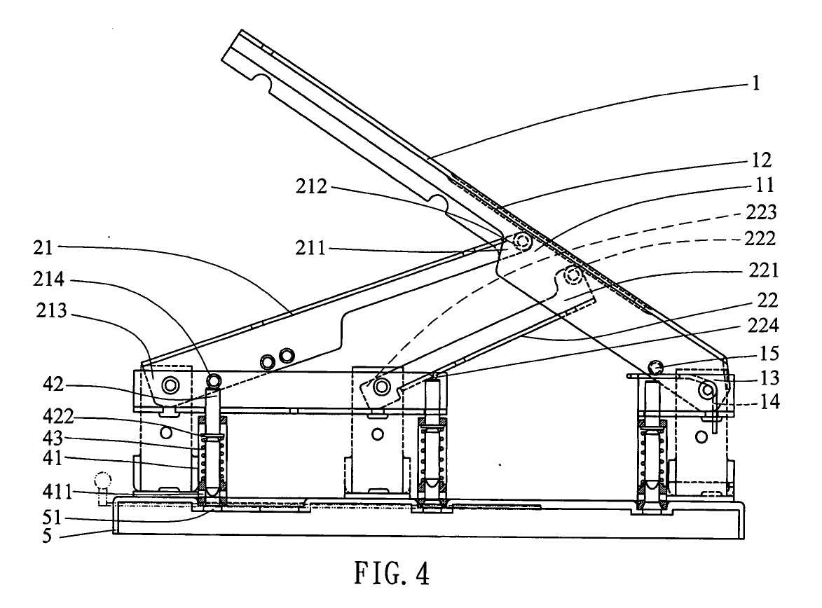

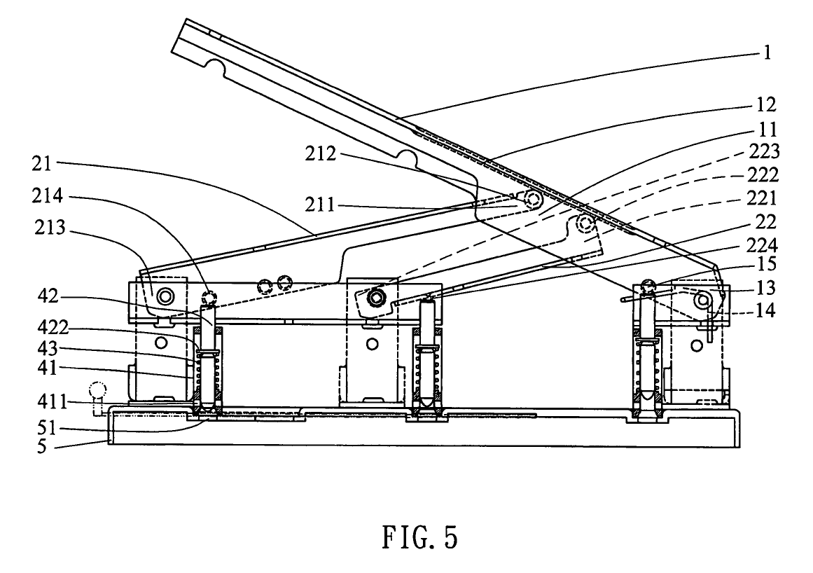

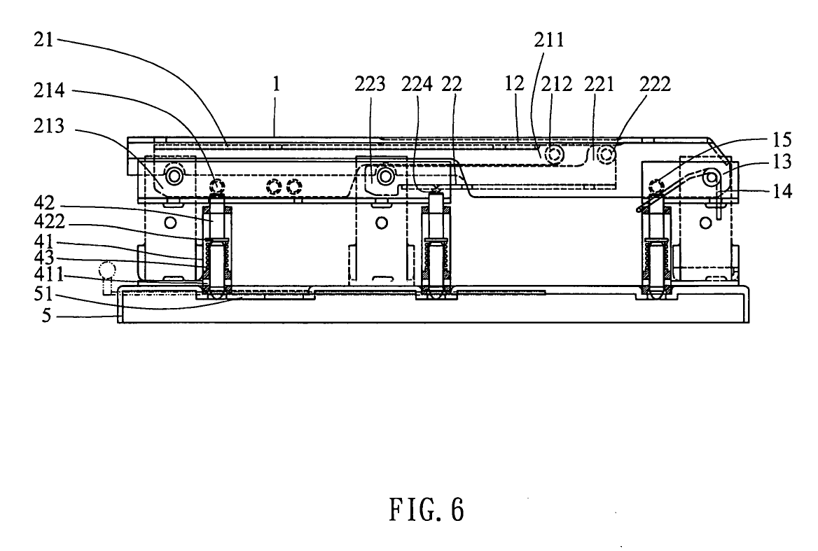

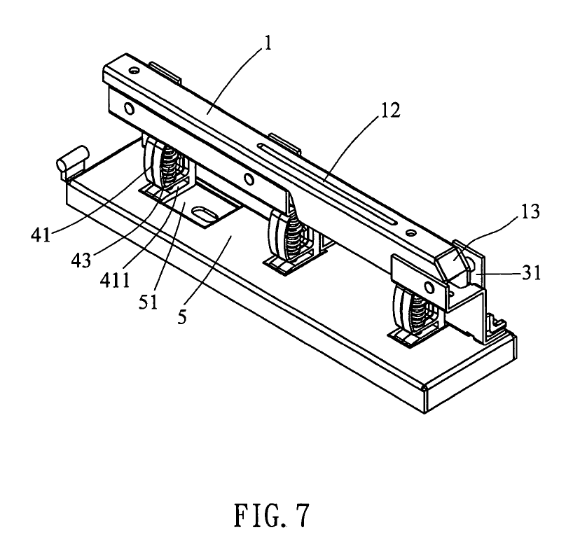

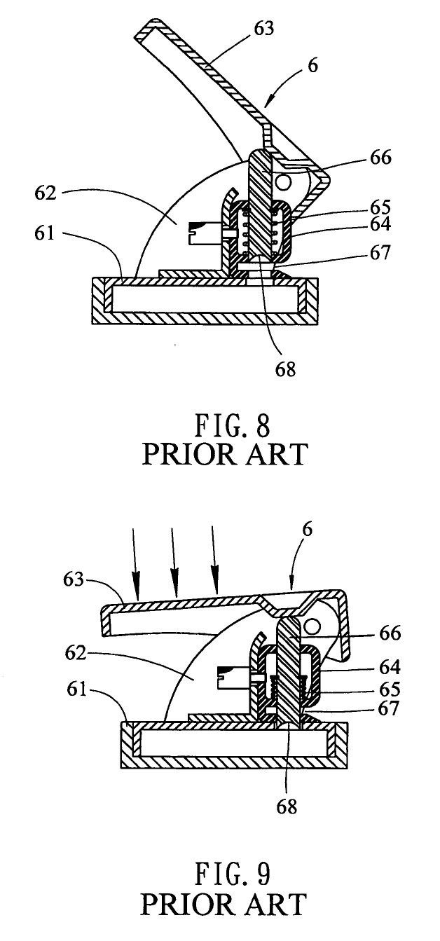

As shown in FIGS. 4 to 7, when pivoting the arm 1 downward, the first roller 212 of the first link 21 moves along the rail 12 and the first link 21 is pivoted and lowered. The second pin 214 pushes the punch head 42 to move downward to punch the sheets of paper. The second roller 222 of the second link 22 moves along the rail 12 when continuously pivoting the arm 1, the second link 22 is pivoted and lowered. The flange 224 pushes the punch head 42 corresponding thereto downward to punch the sheets of paper. When the arm 1 is pivoted and reaches to its lowest position as shown in FIG. 6, the first pin 15 pushes the punch head 42 corresponding thereto downward to punch the sheets of paper. The punch heads 42 punch the sheets of paper one by one at different positions and times so that the reaction force applied to the punch heads 42 is less and the user can easily operate the paper punch with less force.

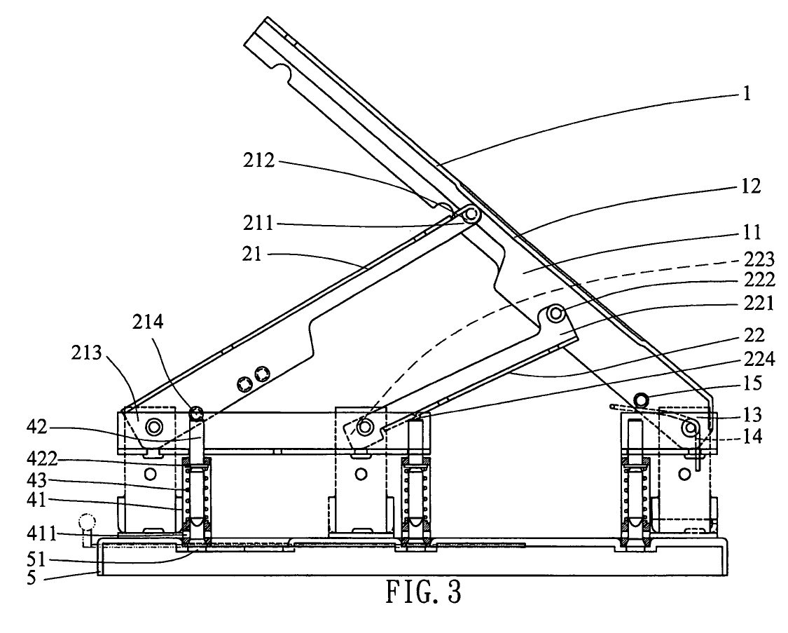

When releasing the arm 1, the torsion spring 14 pushes the arm 1 backward and the first and second links 21, 22 are pivoted upward to the status as shown in FIG. 3.

While we have shown and described the embodiment in accordance with the present invention, it should be clear to those skilled in the art that further embodiments may be made without departing from the scope of the present invention.

What is claimed is:

1. A paper punch comprising:
an arm having a pivotal end in which a torsion spring is received, an elongate recess is defined in the arm;
a link unit including a first link and a second link, the first link including a first rolling end movably engaged with the elongate recess in the arm and a first fixed end, the second link including a second rolling end movably engaged with the elongate recess in the arm and a second fixed end, the second rolling end located beneath the first rolling end;
a support part having a plurality of connection plates connected thereto, the pivotal end of the arm, the first fixed end of the first link and the second fixed end of the second link respectively connected to the connection plates, a plurality of through holes and an aperture defined through the support part;
a plurality of punch units each having a frame, a punch head and a spring which is mounted to the punch head, the frames connected beneath of the support part, respective top ends of the punch heads extending through the through holes in the support part, the first link, the second link and the arm respectively contacting the top ends of the punch heads, respective lower ends of the punch head movably extending through the frames, and the support part and the punch units fixed to a base.

2. The paper punch as claimed in claim 1, wherein a rail extends from an inside of the elongate recess of the arm so as to guide the first and second rolling ends of the first and second links.

3. The paper punch as claimed in claim 2, wherein the first link includes a first roller connected to the first rolling end and the second link includes a second roller connected to the second rolling end, the first and second rollers are movable in the elongate recess.

4. The paper punch as claimed in claim 3, wherein the first and second rollers are movable on the rail.

5. The paper punch as claimed in claim 1, wherein a first pin connected to the arm and an end of the torsion spring contacts against the first pin.

6. The paper punch as claimed in claim 5, wherein the other end of the torsion spring is inserted into the aperture.

7. The paper punch as claimed in claim 5, wherein the first link includes a second pin.

8. The paper punch as claimed in claim 7, wherein the second link includes a flange extending outward from a lower end thereof.

9. The paper punch as claimed in claim 8, wherein the first pin, the second pin and the flange are in contact with the respective top ends of the punch heads.

10. The paper punch as claimed in claim 1, wherein each of the punch heads includes a groove with which a clip is engaged, the springs in the frames contacts the clips respectively.

11. The paper punch as claimed in claim 1, wherein the support part includes a fixing plate which is fixed to the base.

12. The paper punch as claimed in claim 1, wherein each of the frames includes a slot located at a lower end thereof.

13. The paper punch as claimed in claim 1, wherein the base includes a plurality of engaging recesses with which the frames are engaged.
